(19) United States
(12) Patent Application Publication
(10) Pub. No.: US 2014/0006166 A1
(43) Pub. Date: Jan. 2, 2014

(54) SYSTEM AND METHOD FOR DETERMINING OFFERS BASED ON PREDICTIONS OF USER INTEREST

(71) Applicants: Chi-Hao Chiang, Vancouver (CA); Andrew Csinger, Vancouver (CA)

(72) Inventors: Chi-Hao Chiang, Vancouver (CA); Andrew Csinger, Vancouver (CA)

(73) Assignee: Mobio Technologies, Inc., Vancouver (CA)

(21) Appl. No.: 13/554,431

(22) Filed: Jul. 20, 2012

Related U.S. Application Data
(63) Continuation of application No. 13/538,693, filed on Jun. 29, 2012, now abandoned.

(51) Int. Cl. G06Q 30/02

(52) U.S. Cl. 705/14.64; 705/14.66

(57) ABSTRACT

Systems and methods for recommending offers to a user are implemented via one or more processors operating on one or more server systems. The systems and methods include receiving attribute data associated with one or more target users. An offer is determined for transmittal to the one or more target users. The offer is based at least on at least a portion of the attribute data analyzed by a predictive process including a decision tree combined with a clustering process. An offer is output that is configured to be received by the one or more targeted users.

### FIELD OF THE INVENTION

The present invention relates generally to systems and methods for determining offers based on user interests, and more particularly, systems and methods to determine offers for users of electronic commerce systems based on predictions of user interests.

### BACKGROUND

A variety of recommender systems are currently being used in Internet-based electronic commerce to increase the relevance of products and services offered to potential purchasers. Recommender systems include computer-implemented services that recommend to a user or purchaser items selected from a data structure storing data related to the items.

Prior recommender systems includes systems where offers are produced based on similarity where if a determination is made that a user likes a first item, the user is then deemed to likely enjoy other items that are similar to the first item. Similarity in such prior systems is defined via a predefined distance metric.

In some recommender systems, collaborative filtering is used, which is a statistical technique that uses the transactional history of many users to generate a predictive model of users' preferences over possible offers. Collaborative filtering techniques can produce accurate models of user preferences, but lack transparency.

Other prior recommender systems use predictive technologies and require intensive computational resources. Such systems can be dependent on how informative different features are and on the ability of the system to search the feature space for an optimal combination of features.

### SUMMARY OF THE INVENTION

According to one aspect of the present disclosure, a computer-implemented method recommends offers to a user. The method is implemented via one or more processors operating on one or more server systems. The method includes receiving attribute data associated with one or more target users. An offer to transmit to the one or more target users is determined. The offer is based on at least a portion of the attribute data analyzed by a predictive process including a decision tree combined with a clustering process. The offer is configured to be received by the one or more targeted users and is output.

According to another aspect of the present disclosure, a system for recommending offers includes one or more non-transitory physical computer-readable storage media configured to store attribute and transaction data associated with one or more target users. The attribute and transaction data include target user identifications, offer attributes, and prior target user transaction data. A recommender component includes one or more communication interfaces for connecting with the storage media. The communication interfaces are configured to send and receive data. The recommender component further includes one or more processors operative to generate a recommended offer for at least one of the one or more target users by implementing acts including receiving the attribute and transaction data from at least one of the one or more storage media. The recommended offer is determined based on at least a portion of the attribute and transaction data analyzed by a predictive process including a decision tree combined with a clustering process. The offer is output via at least one of the one or more communication interfaces. The outputting of the offer is configured to be received by the one or more target users.

According to yet another aspect of the present disclosure, a method includes receiving in a recommender system attribute and transactional data stored on one or more memory devices. The attribute and transactional data are associated with one or more target users of the recommender system. An offer to transmit to the one or more target users is determined via one or more processors associated with the recommender system. The offer is based on at least a portion of the attribute and transaction data analyzed by a predictive process including a decision tree combined with a clustering process. The offer is output via one or more communication interfaces associated with a network. The outputting of the offer is configured to be received by the one or more target users.

According to further aspects of the present disclosure, one or more physical machine-readable storage media include instructions which, when executed by one or more processors, cause the one or more processors to perform the above methods.

Additional aspects of the present disclosure will be apparent to those of ordinary skill in the art in view of the detailed description of various embodiments, which is made with reference to the drawings, a brief description of which is provided below.

### BRIEF DESCRIPTION OF THE DRAWINGS

Features and advantages of the present disclosure will become more apparent from the following detailed description of exemplary embodiments thereof taken in conjunction with the accompanying drawings in which:

FIG. 1 illustrates a system for determining offers, including server(s) for hosting a recommender system and database, according to one aspect of the present invention.

FIG. 2 illustrates an exemplary relational dataset according to one aspect of the present invention.

FIG. 3 is an exemplary flow diagram for constructing decision trees for relational data, such as the data illustrated in FIG. 2, including a process for creating partitions, according to one aspect of the present invention.

FIGS. 4A-4B illustrates an exemplary predictive decision tree and matrix, constructed from the exemplary relational data in FIG. 2, including partitions of select relational data according to one aspect of the present invention.

FIG. 5 is an exemplary flow diagram for constructing decision trees for relational data including a clustering process for creating sub-partitions of select data, according to one aspect of the present invention.

FIGS. 6A-6B illustrates an exemplary predictive decision tree and matrix, including the subpartitioning of select partitioned relational data, according to one aspect of the present invention.

While the present disclosure is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While the present disclosure is susceptible of embodiment in many different forms, there is shown in the drawings and will herein be described in detail various aspects of the invention with the understanding that the present disclosure is to be considered as an exemplification of the principles of the invention and is not intended to limit the broad aspects of the invention to the aspects illustrated.

Electronic commerce via the Internet can be greatly enhanced by implementing on computer systems, such as backend server(s), processes that model users or potential purchasers and anticipate their preferences. These computer-implemented processes can then be used to determine offers to send to the user during the user's online session. It can be particularly desirable for the offers to be transparent to increase confidence that the offer is providing the user an enhanced on-line purchase experience. A desirable system has the ability to accommodate users with varying levels of sophistication and experience. Transparency in the offer is especially desirable where it is not immediately apparent to a user why they received a particular offer. In contrast, offers that are opaque or that may be poorly targeted can cause distrust in future offers and lead to general apathy by the user toward future interactions involving an offer.

Users of Internet-based electronic commerce systems receive increasingly many inducements, often including different varieties, with the intention of furthering the businesses of various online vendors. These inducements, also referred to as offers, generally involve an exchange of value between an online vendor and an online user. For example, users may receive offers such as discounts on goods and services, in exchange for making a bulk purchase, referrals, or marketing information such as personal descriptions and preferences. When a user receives an offer that is of interest to the user, user experience is enhanced, as is the likelihood of a successful value exchange (e.g., the user accepting the online vendor's offer). Increasing the rate of successful offers by a vendor improves the overall value of the vendor. In contrast, poorly-targeted offers come at the detriment of vendor value; such offers can confuse or even irritate the user, engendering negativity toward the vendor. As discussed above, it can be a desirable goal to maintain a favorable rate of successful offers. Similarly, it can also be desirable for the vendor to minimize the effects of poorly-targeted online offers.

In certain technical aspects of the present disclosure, a computer-implemented system makes recommendations for offers based on explainable predictions of user interests. A desirable effect can include that the recommendations are determined based on explainable predictions of user interests, that the users are given improved transparency about offers they receive, and/or that users are given an ability to influence offers they receive in the future. For example, it is contemplated that in certain aspects of a computer-implemented method or system, the availability of explanations are used to enable a user to affect their opinions on received recommendations (e.g., offers), improve future recommendations, and thus, improves the user's online experience.

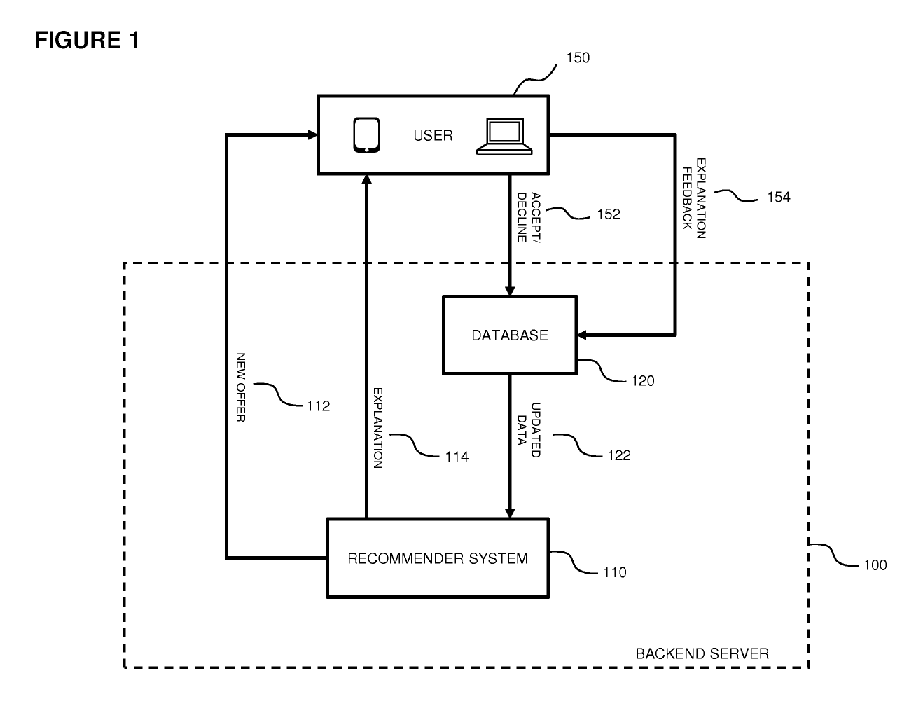

Referring now to FIG. 1, a system diagram is illustrated for one non-limiting exemplary aspect contemplated by the present disclosure. System block 100 represents a server, or multiple servers, on which a recommender system 110 and a database 120 are hosted. For example, the recommender system 110 may reside on one server and the database 120 may reside on another server, or both may reside on the same server. The servers could be a part of the same infrastructure or system block 100 or the servers could be separated.

The elements illustrated in the system diagram of FIG. 1 can include one or more components including interfaces that allow the illustrated elements to communicate with each other. For example the database 120 can include components that allow the database 120 to receive and store new information and to transmit stored information to the recommender system or module 110. Similarly, the recommender system 110 can include components that allow the recommender system 120 to receive data for the database 120 and transmit information outside of the recommender system 110, such as requests for data from the database 120 or inducements (e.g., offers) to potential purchasers (e.g., users). The various combinations of components and the hardware associated with the system, including backend server(s) 100, will be apparent to those skilled in the field of the present disclosure. For example, various additional components of the system can include various operating systems, at least one or more processing units, one or more storage units, one or more memory units, one or more input devices, one or more output devices, one or more input/output device, one or more bus interfaces, and/or one or more external system interfaces, the configurations of which will be apparent to those skilled in the field of the present disclosure.

Recommender system 110 can include a set of instructions implemented on one or more processors for determining an offer transmittal 112 that aligns with the interests of a user 150. It is further contemplated that is can be desirable for the set of instructions to also include determining an explanation transmittal 114 for the offer. The determination of the offer and/or the explanation are at least partially based on user and offer information as well as past transactions stored in and retrieved from the database 120. After the offer is determined or calculated by the recommender system 110, it is then transmitted or outputted via an interface from the recommender system 110 to a user 150 associated with the recommender system. The user 150, through the desktop or mobile interface, can have an option at to accept or decline a received transmitted offer 112. Similarly, the user 150 can also have the option to provide feedback or commentary to a received transmitted explanation 114 that is also transmitted or output from an interface of the recommender system. Thus, the user 150 can directly scrutinize the explanation, enabling refinements of future offers. The offer 112 and explanation 114 can be transmitted to the network from the backend server(s) 100 and received by the user 150. As a response to the offer 112 and explanation 114, the user 150 has the option to transmit to the network an acceptance or declination transmittal 152 and an explanation feedback transmittal 154 that are received by the backend server(s) 100. The received user responses 152 and 154 are then stored and used to update the database 120 which in turn can transmit updated data 100 to be used by the recommender system 110. The updated data may either be transmitted directly to the recommender system 110, or the updated data may be stored on the database 120 awaiting a request from the recommender system 110 for the updated data.

It is contemplated that in some aspects of the present disclosure, the offer transmittal 112 and explanation transmittal 114 can be output from the same or different output interfaces of the recommender system 110. Similarly, the accept/decline transmittal 152 and explanation feedback transmittal 154 from the user 150 can be output from the same or different output interfaces of the user 150. It is also contemplated that the reception of transmittals 112 and 114 can be made by the same or different input interfaces of user 150, and transmittals 152 and 154 can also be made by the same or different input interface of the back end server 100 or database 120. In addition, it is also contemplated that communications of updated data between database 120 and recommender system 110 or within the back end server 100 can occur through the same or different input/output interfaces. It is yet further contemplated that each unit including the back end server 100, the recommender system 110, the database 120, and/or the user 150 can have one or more input/output interfaces. Some of the interfaces may be dedicated to certain operations and some interface can combine different operations.

It is contemplated that the explanation feedback transmittal 154 may include passive, active, or a combination of active and passive feedback. In certain aspects it is desirable to prompt a user 150 for explicit feedback (e.g., active) that may be in the form of a simple yes or no question or a more complicated response. In other aspects, it may be desirable to monitor the passive activity of user 150 at the time an offer is sent, such as mouse clicks or certain types of data that may be tracked via cookies.

User 150 can include a desktop or mobile interface having, for example, a graphical user interface. The desktop or mobile interface is connected to the Internet or other type of network and is associated with a user or potential purchaser. Thus, it would be understood that information exchanged between the backend server(s) 100 and the user 150 occur over a network than can include, for example, wireless networks, WAN, and LAN systems. Furthermore, it would be understood that an interaction loop can exist between the user 150 and the back end server(s) 100 (e.g., recommender system 110 and database 120), which in turn can provide improved offers (e.g., more relevant to a user's preferences) and acceptable explanations over time by the recommender system 110 as the database receives more data about a user.

As discussed above, the system diagram illustrated in FIG. 1 is one exemplary aspect of the present disclosure. Other exemplary computer and networked system are also contemplated for implementing the explainable offers embodiments described herein. For example, back end server 100 can be in communication with multiple user interfaces rather than just user 150. Furthermore, database 120 may be one of a plurality of database devices for collecting and storing data for use by the recommender system, and furthermore, one or more of the plurality of databases can be on a separate backend server. Similarly, the recommender system 110 may also operate as one or more modules implemented on one or more communicatively connected backend servers. The communications medium between all the various components can include any one of a variety of networks or other type of communication connections as known to those skilled in field of the present disclosure. For example, the communication medium may be the Internet, an intranet, or other network connection by which Internet users or potential purchasers may send and receive communications from backend server systems. It is further contemplated that the processes being implemented on the system may written in any one of a variety of computer programming languages, such as, C, C++, C#, Java®, or any combination(s) thereof, or other available programming languages.

It is contemplated that a system, such as the one described in the context of FIG. 1, may be desirable for generating explanatory models using decision trees that take advantage of available descriptive attributes of users and offers. Decision trees include data structures that result from recursively partitioning a dataset. The partition of the dataset can be obtained according to a value of a feature of the data. The result is that data in any given partition are deemed explainable given the features used to generate the partition. The explanations based on the features can be in the form of readily interpretable rules, which makes the use of decision trees desirable for predictive modeling.

It is further contemplated that the generation of explanatory models for a recommender system using decision trees can be further improved by introducing latent clustering to data generated by a decision tree. While decision trees alone may offer efficient computing in terms of memory and computing speed constraints, their predictive performance may not lead to a desired outcome. Thus, to improve upon explanatory models based on decision trees alone, the predictive accuracy of an explanatory model, such as a computer-implemented process for recommender system 110, is improved by adding clustering aspects. Clustering is a technique that can be applied to the recommender system 110 for generating highly optimized numerical representations based on hidden attributes. Applied alone clustering techniques can be difficult to interpret, but in combination with decision trees can provide a desirable application for a recommender system for determining offers. A process implemented in the recommender system that combines these two features can apply the explainability of decision trees as well as the accuracy from clustering. This further allows recommendations relevant to a particular user to be generated while also allowing explanations for the recommendation are made available to the user for feedback and additional refinement for future offers.

It is contemplated that in certain non-limiting exemplary aspects of the present disclosure a recommender system combines decision tree learning with hidden variable modeling or clustering. Such aspects can include the additional (hidden) structure in the leaves of the decision trees being inferred. For example, this exemplary aspect can be understood as one non-limiting way of introducing an additional split-level to a decision tree with split values inferred through clustering.

It is contemplated that in certain non-limiting aspects, data of interest can describe users, offers, and transactions by users on offers (e.g., viewed, not viewed). For example, input data can include an attribute table for users (e.g., a table with values of various attributes for users), an attribute table for offers, and a table for transactions. A users table can be defined in which each column corresponds to an attribute (e.g. age, gender) and rows correspond to different users. Similarly, an offers table can be defined representing attribute values for offers. A transactions table can be defined such that each column represents a different transaction and rows correspond to different user-offer pairs. For example, that user x viewed offer y can be recorded in a <x, y> row in a column corresponding to a “viewed” transaction.

More generally, it is contemplated that a data table D for m attributes/transactions containing n data cases is described by the relationship of D={ [symbol] id₁, t₁¹ . . . , t₁^{m} [symbol] , . . . , [symbol] idₙ, tₙ¹ . . . , tₙ^{m} [symbol] }. The i-th data case [symbol] idᵢ, tᵢ¹ . . . , tᵢ^{m} [symbol] has identifier idᵢ for i=1, 2, . . . , n. For example, in a user attribute table, idᵢ is a user ID. For transaction tables, idᵢ is a user-offer pair including the ID of a known user and that of a known offer. For a user table, each term tᵢ⁴ is the value of the j-th attribute for the individual specified by idᵢ, and for a transaction table, tᵢ^{j} specifies the value of the j-th transaction for the user-offer pair specified in idᵢ.

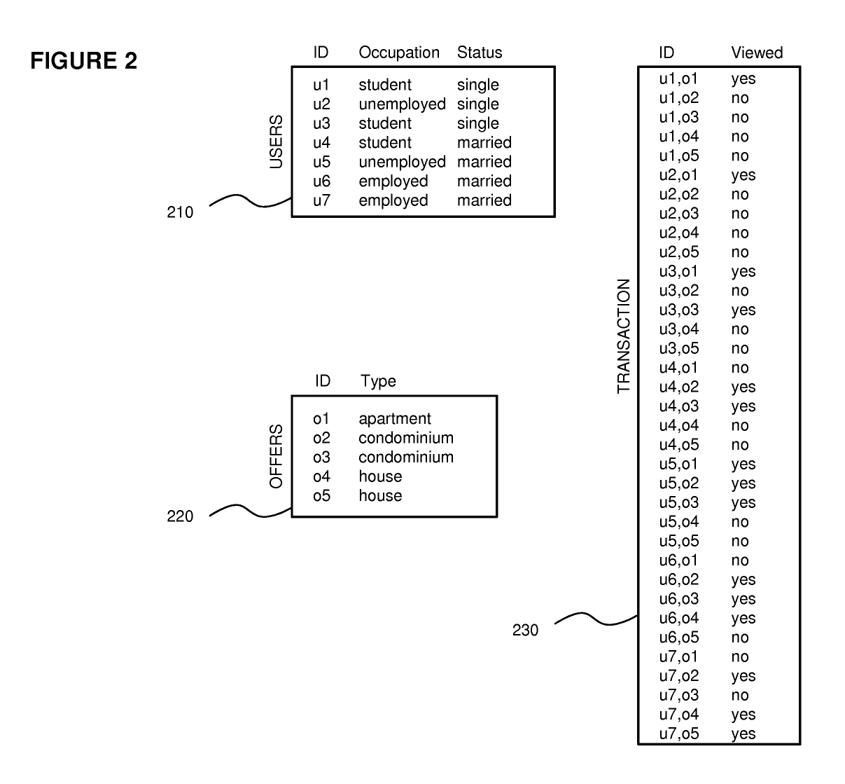

Referring now to FIG. 2, a non-limiting exemplary relational dataset according to one aspect of the present disclosure is illustrated that includes user attributes, offer attributes, and transactions. A user attribute table 210, that may for example be retrieved from a database and processed by a recommender system, is defined that includes information about (e.g., two) user attributes—e.g., occupation and marital status—for a plurality (e.g., seven) of unique users. An offer attribute table 220 is also defined that includes a plurality (e.g., five) of different properties that are generically referred to as offers (e.g., o1, o2, . . . ). A transaction table 230 is then defined that includes records for the ‘viewed’ transactions for each user-offer pair (e.g., u1,o1; u1,o2; . . . ). While FIG. 2 illustrates a specific exemplary real-estate model, the illustrated relational dataset is understood to be one of many model configurations contemplated by the present disclosure and described in a general or generic context in the above paragraph by data table D for m attributes/transactions containing n data cases.

To model a target attribute in a given attribute table, a decision tree of the target attribute is built in terms of other attributes in the table. In certain exemplary aspects, a decision tree for attribute data can be defined in the following paragraph identified as Definition 1:

### Definition 1

Let D be an attribute table with attributes A={a₁, a₂, . . . , aₖ}. A decision tree for table D is a data structure T^{D}(x; F)={Sᵥ_{₁}, . . . , Sᵥ_{_{c}}} defined for a target attribute a*∈A, where F⊂A\a* (e.g., all attributes in A except a*) is the set of input attributes and x∈F is the split attribute. Each branch Sᵥ_{ᵢ}, is itself a decision tree T^{D}^{ᵢ}(yᵢ; F\x) where v₁, . . . , v_{c} are possible values of attribute x, Dᵢ is a partition of D for which x=vᵢ where i=1, . . . c, and yᵢ∈F\x is one of the remaining attributes after splitting on x. If no splits are specified, i.e. x=NULL, then T^{D} (NULL; F)={ } is a leaf and D is not partitioned.

Decision trees are understood to be recursive structures and branches of any node in the tree links to either a leaf or a sub-tree. The lea(ves) correspond to a minimal data partition in which no sub-partitions are defined by the tree. In a simplified exemplary aspect of a single attribute table, a decision tree can be constructed using a generic process, such as the one described in the below paragraph and identified as Process 1. One input attribute can be used to split the input data, and the input attribute can be chosen as the one that maximizes some heuristic score. For example, in a certain models the heuristic score selected to be maximized may be information gain or gain ratio, which measures the gain in information from the pre-split data to the post-split data. For each partition resulting from the split, further partitioning is done by a recursive call of the process. This recursion proceeds until the data has been exhausted, or that the input attribute set is empty, or that no remaining attribute yields acceptable score, at which point a leaf is returned. A generic decision tree process is listed below.

Process 1—compute_tree(D, A, a*, ε).

Inputs for the process include attribute table D with non-target attributes A and target attribute a*. The heuristic threshold for the process is defined as. The process then proceeds according to the following steps:

| | |
|---|---|
| (1) | Let T^{D} = { } |
| (2) | IF D is empty or A is empty |

| | |
|---|---|
| (3) | Let T^{D} = T^{D}(NULL;A) |

| | |
|---|---|
| (4) | ELSE |

| | |
|---|---|
| (5) | Choose attribute x from A to split D that has the maximum |
| | heuristic score |
| | score(x,D;a*) |
| (6) | IF score(x,D;a*) ≧ ε |

| | |
|---|---|
| (7) | FOR each value v of x |

| | |
|---|---|
| (8) | Let Dᵥ ⊂ D be cases of D where x = v |
| (9) | Compute Sᵥ= compute_tree(Dᵥ,A\x,a*,ε) |
| (10) | Add Sᵥ to T^{D} |

| | |
|---|---|
| (11) | ELSE |

| | |
|---|---|
| (12) | Let T^{D} = T^{D}(NULL; A) |

| | |
|---|---|
| (13) | RETURN T^{D} |

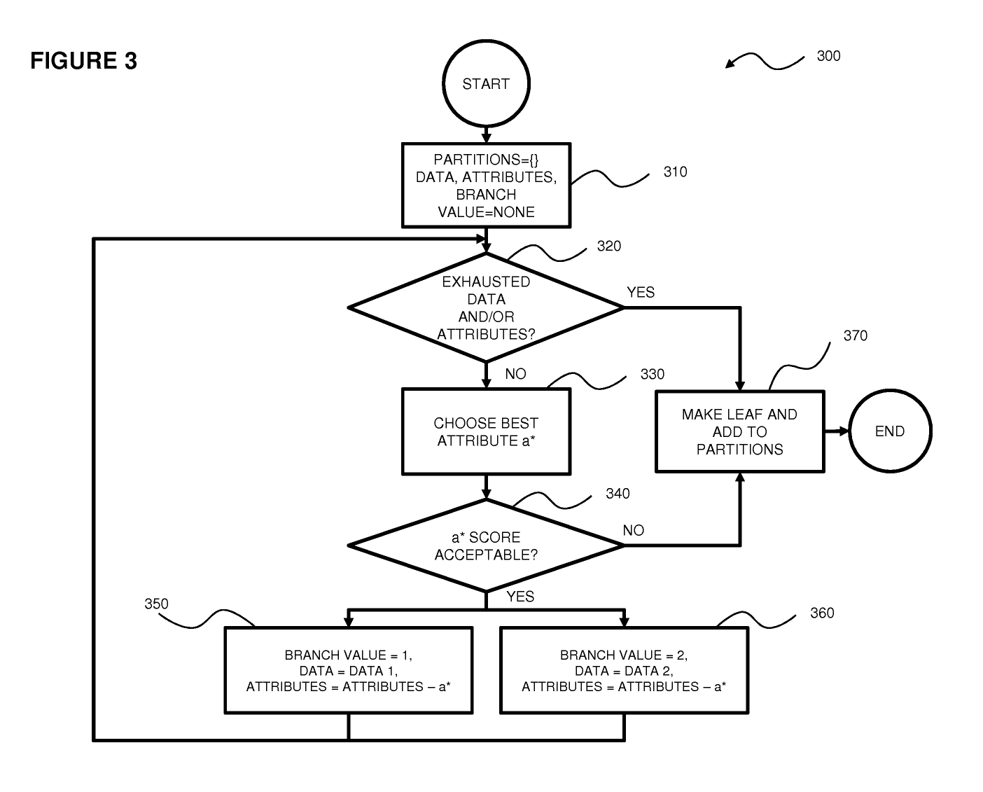

Referring now to FIG. 3, an exemplary flow diagram corresponding to Process 1 is shown for constructing decision trees for relational data, such as the data illustrated in FIG. 2, including a process for creating partitions (e.g., for generating leaves). Beginning at step 310, an initial dataset and attributes are defined. Next, at step 320, similar to line 2 of Process 1, a decision box is used to determine that neither the dataset nor the attribute set are empty 320. If the dataset and attribute set are not empty, at step 330, a “best” attribute a* is selected from the attribute set, where “best” can be defined with respect an exemplary metric such as information gain, as discussed above. At step 340, similar to line 6 of Process 1, if attribute a* satisfies or exceeds a predetermined test score (e.g. some predefined minimum information gain), then the process described by line 7 of Process 1 is selected to split the dataset to yield two branches, 350, 360 with respective data subsets, with one data subset per value of the split attribute. The flow diagram shown in FIG. 3 is exemplary and assumes that a* has two values, but in general it can have more values. Next, moving from 350, 360 and recursing back to step 320—similar to the recursive step from line 9 to line 2 of Process 1, a subtree is generated for each branch using the respective data subsets. Back at step 320, if the dataset or attribute set is empty or if no adequately informative attributes remain, a leaf partition 370 is generated and stored as also described by line 3 and 12 of Process 1.

Process 1, which is described above, is a generic decision tree process that builds “top down”. Another class of decision tree learning produces decision trees in a “bottom up” manner. It is contemplated that in certain aspects, any process that produces decision trees using a given dataset and attributes can be used for creating a model for the recommender system.

It is further contemplated that decision trees can be constructed in certain to model transactions in terms of attributes of users and offers. One exemplary transaction model according to an aspect of the present disclosure is defined in the following paragraph identified as Definition 2.

### Definition 2

Let D={D^{O}, D^{U}, D^{tr}} be an offer attribute table, user attribute table, and a transaction table, respectively, that yields offer attribute A^{O}, user attributes A^{U}, and transactions A^{tr}. Let a*∈A^{tr} be the target transaction. A decision tree for a* is a data structure T^{D}(x; F)={Sᵥ_{₁}, . . . , Sᵥ_{_{c}}} where F⊂A^{O}∪A^{U} is a set of input attributes and x∈F is the split attribute, i.e. the “root”, and v₁, . . . , v_{c} are possible values of attribute x. Each branch Sᵥ_{ᵢ} is itself a decision tree T^{D}^{ᵢ}(yᵢ; F\x) where yᵢ∈F\x. Dᵢ={Dᵢ^{O}, Dᵢ^{U}, Dᵢ^{tr}} represents the remaining data cases of each table after filtering on x=vᵢ. If no splits are specified, i.e. x=NULL, then T^{D}(NuLL; F)={ } is a leaf and D is not partitioned.

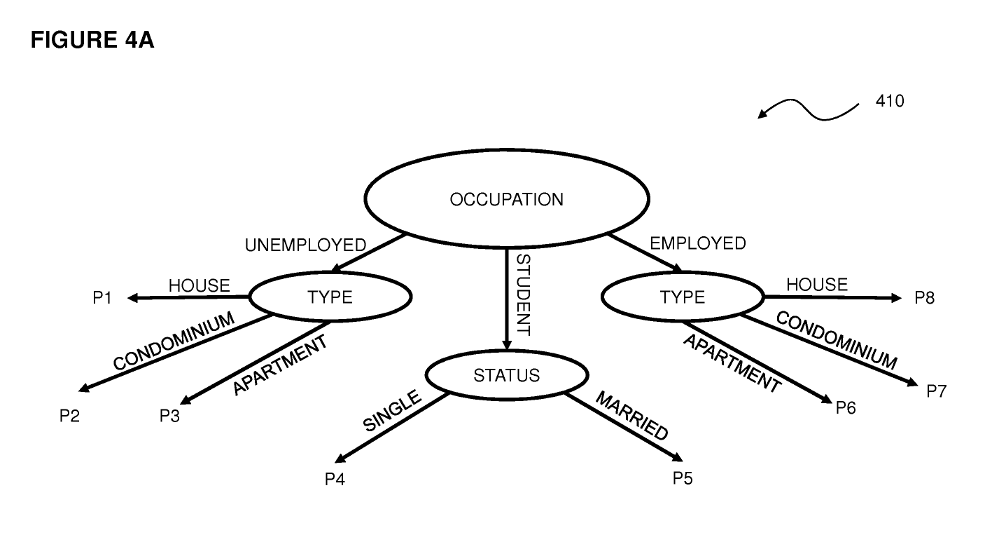

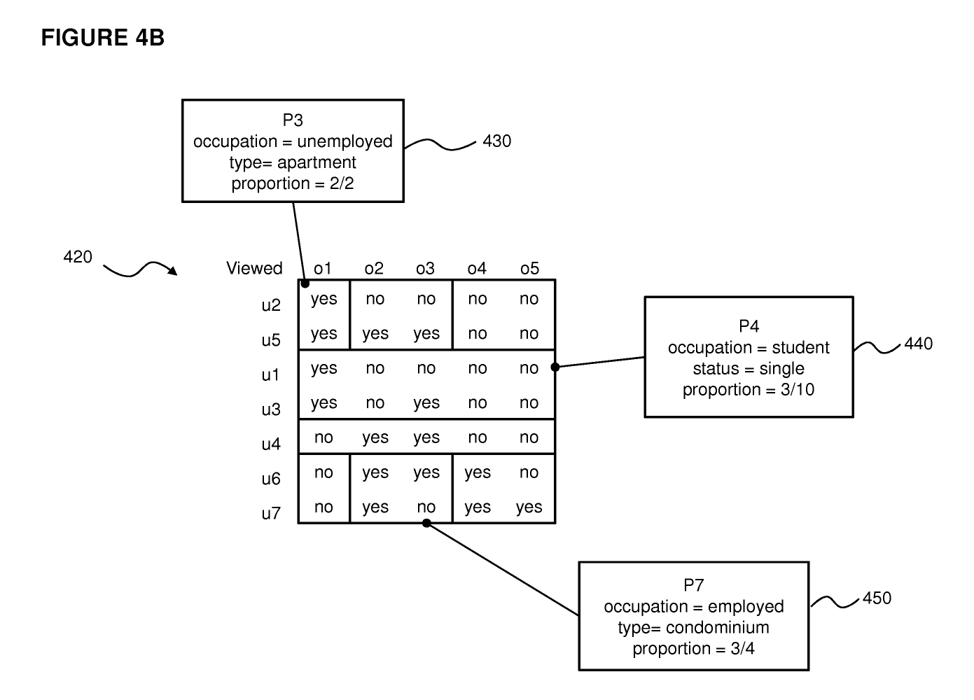

Process 2 below is a modified version of Process 1 and constructs decision trees for relational data, such as the exemplary decision tree shown in FIG. 4A using the exemplary data shown in FIG. 2.

Process 2—compute_trans_tree(D^{O}, A^{O}, D^{U}, A^{U}, D^{tr}, ε).

Inputs for the process include offer attribute table D^{O}, user attribute table D^{U}, offer attributes A^{O} with attributes A^{U}, and transaction table D^{tr} including data for target relation a*. The heuristic threshold for the process is defined as. The process proceeds according to the following steps:

Let T^{D} = { }
IF D^{tr} is empty or, A^{O} and A^{U} are empty

Let T = T(NULL;A^{O} ∪ A^{U})

ELSE

Choose root attribute x from A^{O} ∪ A^{U} that maximizes score(x)
IF score(x) ≧ ε

FOR each value v of x

IF x chosen from A_{O}

Let Dᵥ^{O} ⊂ D^{O} be cases of D^{O} where x = v
Let Ā^{O} = A^{O}\x , Ā^{U} = A^{U}

ELSE IF x chosen from A_{U}

Let Dᵥ^{U} ⊂ D^{U} be cases of D^{U} where x = v
Let Ā^{U} = A^{U}\x , Ā^{O} = A^{O}

Let Dᵥ^{tr} ⊂ D^{tr} be cases of D^{tr} where

(i) the offer ID appears in Dᵥ^{O} and
(ii) the user ID appears in Dᵥ^{U}

Compute Sᵥ = compute_trans_tree(Dᵥ^{O},Ā^{O},Dᵥ^{U},Ā^{U},Dᵥ^{tr},ε)

Add Sᵥ to T

ELSE

Let T = T(NULL; A^{O} ∪ A^{U})

RETURN T

The flow of Process 2 is generally similar to that of Process 1, which was illustrated in FIG. 3, with the distinction that the input dataset is a relational dataset, such as the exemplary dataset illustrated in FIG. 2. Furthermore, Process 2 describes an attribute table that can have more than one attribute, and thus, Process 2 can affect how data splitting is performed.

Referring now to FIGS. 4A-4B, a non-limiting exemplary decision tree is illustrated that is constructed from the exemplary relational data in FIG. 2, including exemplary partitions of select relational data. More specifically, FIG. 4A provides an example of a sample decision tree 410 generated in terms of attributes of users and offers. A plurality of partitions (e.g., P1 to P8) are illustrated for the exemplary transaction table 230 from FIG. 2. The partitions are also illustrated in the two-dimensional matrix 420 in FIG. 4B, which corresponds to the leaves, P1 to P8, on the decision tree 410. The partitions are revealed in the data matrix 420 by sorting the rows and columns according to the attributes in the decision tree 410. The partitions are distinguished by the different shading and separate outlining in matrix 420. Illustrative examples are shown for partition P3 and P4 of matrix 420. Box 430 describes partition P3, which includes transaction IDs u2,o1 and u5,o1 and their associated viewing results from transaction table 230. Box 440 describes partition P4, which includes the transaction IDs u1,o1; u1,o2; u1,o3; u1,o4; u1,o5; u3,o1; u3,o2; u3,o3; u3,o4; and u3,o5, and their associated viewing results.

The use of decision trees in a recommender system can be beneficial because decision trees support ease-of-interpretation, as each path from root-to-leaf in the tree corresponds to a rule in terms of known attributes. For example, the P7 partition 450 of the “viewed” transaction in FIGS. 4A-4B for full-time workers (e.g., u6, u7 from the users table 210) and condominiums (e.g., 02, 03 from offers table 220) yields the prediction rule. For example, a prediction rule based on any user u and offer o may be that there is a three in four or 75 percent chance that u will view o if u is a full-time employee and o is a condominium.

It is also contemplated that the structure of a rule can form an explanation of the prediction. For example, one explanation that can be made from the above example for any user u and offer o is that some user is expected to view a condominium with a 75 percent chance if the user is a full-time worker. However, the effectiveness of such limited explanations for increasing user engagement and trust may not be readily quantifiable, and thus, could result in improperly targeted offers.

It is contemplated that in some aspects of the present disclosure, an explanation can be understood to be a description of a logical sequence that leads to a recommendation or offer transmitted or outputted to a user. For example, in decision trees, a root-to-leaf path may provide such a logical sequence. An example of this may be illustrated from FIGS. 4A-4B using leaf partition P7, which has three out of four “yes” responses. Suppose viewed (u7,o3) is an unknown quantity—then P7 has three out of three “yes” responses from the three remaining cases in the partition. By recommending o3 to u7 for viewing to a user, an explanation can be transmitted or outputted to the user that u7 falls in leaf P7 (e.g., full-time workers and condominiums), and that three out of three full-time workers viewed condominiums. Given the explanation, a user can then provide feedback about the quality of the explanation through the explanation feedback process. For example, u7 may indicate that the explanation provided is adequate/inadequate (e.g., a binary feedback). More sophisticated forms of feedback can include allowing a user to transmit explanation feedback identifying which part of an explanation is inadequate. So, if u7 feels that the fact (s)he is a full-time worker is not a strong enough justification to recommend a condominium for viewing, user u7 can explicitly indicate so. It is contemplated that in some aspects each or some parts of the explanation will come with an accept/reject functionality for the user.

It is contemplate that the explanation feedback of some aspects can be desirable by improving transparency by showing a user the segmentation employed to generate prediction on which recommendations for offers are based along with allowing users the opportunity to edit or comment on an explanation. The desirability of such aspects is further enhanced with the combination of decision trees and clustering for generating recommendations and explanations to users.

It is contemplated that the accuracy of decision trees can depend significantly on the ability of a prediction process to find “correct” partitions of data. In turn, finding correct partitions of data can depend on the availability of informative attributes, which may or may not be available. If the number of informative attributes is limited, the resulting partitions in a decision tree may harbor significant amounts of unexploited information. However, it is contemplated that in some aspects of the present disclosure it is desirable to discover or determine subpartitions within each (or some) leaf partition(s)—a task called clustering—to make a more complete, and thus more refined or better, use of remaining information in a partition. Subpartitioning via clustering is similar to subpartitioning by another attribute, where in the case of clustering, the subpartitions and their constituents are discovered or determined rather than given.

The determination of clusters within a leaf partition includes a process of introducing a number of clusters and assigning each data point in the leaf partition to one of these clusters. The number of clusters can be predefined or determined generally contemporaneously with the clustering or on the fly. It is contemplated that the assignment of data points to each cluster can be inferred by probabilistic inference. The goal of clustering is to find a more likely or a most likely set of assignments of data in the leaf to the clusters; e.g. find assignments such that the resulting model achieves a desirable (e.g., best) statistical fit to the leaf data. It is contemplated that any technique in the field of the present disclosure for optimizing the assignment of data to a given number of clusters is applicable to some of the aspects of the present disclosure; these can include distance functions, hierarchical Bayesian models, and others.

To further illustrate and describe exemplary aspects of clustering as it may be applied to determining offers, let L^{tr}={x₁, x₂, . . . , xₙ} be a set of transactional data that, for example, is in some leaf partition. Next, suppose that K hidden clusters are introduced. Then, for each xᵢ∈L^{tr} an assignment variable zᵢ (a random variable) can be introduced which can take integer values from 1 to K. An assignment probability distribution can then be expressed as the posterior distribution of assignment variables for the given data, which can be described by the following expression using Bayes' rule:

p(z₁, . . . ,zₙ|x₁, . . . ,xₙ)=p(x₁, . . . ,xₙ|z₁, . . . ,zₙ)p(z₁, . . . ,zₙ)/p(x₁, . . . ,xₙ)

It is contemplated that for clustering aspects where K is known and fixed, an expectation maximization (EM) approach can be applied. An EM process can be a desirable application for parameter estimation in probabilistic models with latent variables. EM is also desirable because it computes the posterior distribution over the assignment variables described above, as well as parameters of each distribution composing the right hand side of the above expression. Possessing an estimate of the posterior distribution over the assignment variables facilitates the selection of the desired assignment of each leaf datum to one of the K clusters. For example, the assignment with the highest posterior probability can be the desired assignment in some aspects of the present disclosure. It is contemplated that other methods known in the field of the present disclosure, such as variational EM or Markov chain Monte Carlo sampling, are also viable alternatives for performing probabilistic inference for a clustering process combined with decision trees. It is further contemplated that selection of an assignment vector that maximizes the above exemplary expression can provide desirable outcomes for the recommender system by enhancing its predictive accuracy.

It is contemplated that once the more likely assignments of data to clusters are determined for each leaf of a decision tree then predictions of user interests using the constructed clustered tree can proceed similar to a non-clustered decision tree.

Process 3 below is a method for generating or constructing a combined predictive model of user interest that can be used to determine offers in a recommender system.

Process 3—compute_cluster_tree(D^{O}, A^{O}, D^{U}, A^{U}, D^{tr}, ε).

Inputs for the process include offer attribute table D^{O}, user attribute table D^{U}, offer attributes A^{O} with attributes A^{U}, and transaction table D^{tr} including data for target relation a*. The heuristic threshold for the process is defined as. The process proceeds according to the following steps:

T=compute_trans_tree(D^{O}, A^{O}, D^{O}, A^{U}, D^{tr}, ε)

Augment D^{tr} and A^{O} with a hidden transaction h

FOR each leaf l in T
Let Dₗ ⊂D^{tr} be the transactional data partition at l
Let A be the remaining attributes at l
Compute the value of h for each data case in Dₗ
Replace l with T^{D}^{ₗ}(h; A)

RETURN T

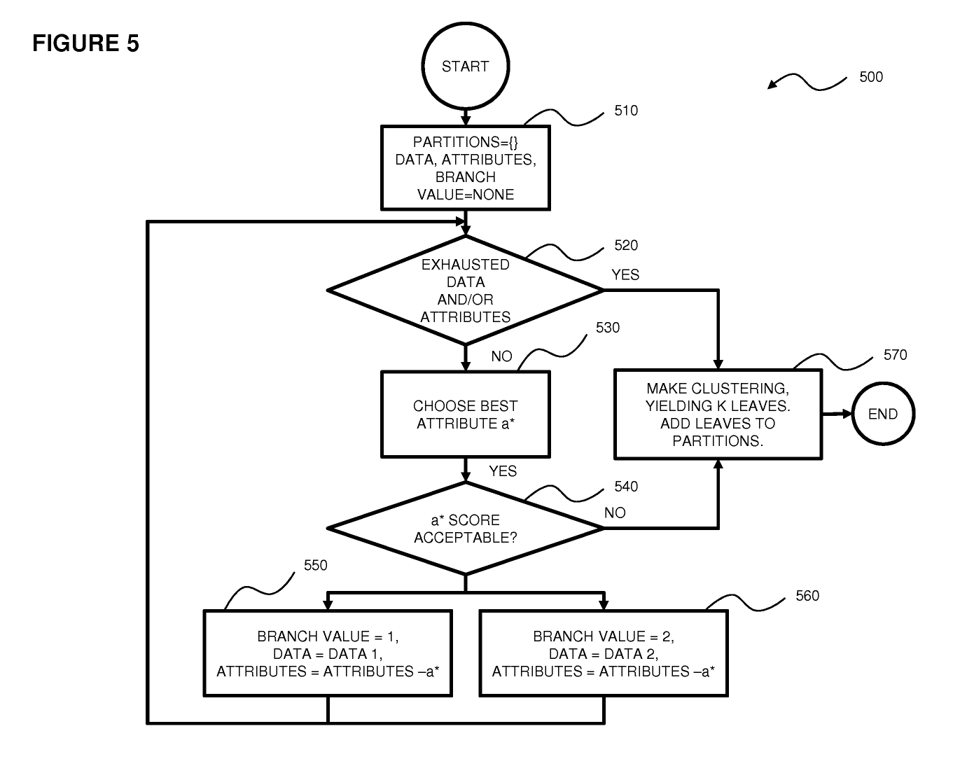

Referring now to FIG. 5, an exemplary flow diagram is shown for constructing decision trees for relational data including a clustering process, such as the one described above in Process 3, for generating or creating leaf partitions (e.g., sub-partitions) of select input data. The flow for the process is similar to that of Process 1 and Process 2, shown and described in the context of FIG. 3, except that instead of creating a leaf partition at step 570, a clustering process is implemented to induce additional sub-partitions. Beginning at step 510, an initial dataset and attributes are defined. Next, at step 520, a decision box is used to determine that neither the dataset nor the attribute set are empty. If the dataset and attributes are not empty, at step 530, the “best” or a desired attribute a* is selected. At step 540, if attribute a* satisfies or exceeds a predetermined test score (e.g. information gain as discussed above), then the process is implemented for splitting the dataset to yield two branches, 550, 560 with respective data subsets, with one per value of the split attribute. The flow diagram shown in FIG. 5 is exemplary and assumes that a* has two values, but in general it can include more values. Next, moving from 550, 560 and recursing back to step 520, a subtree is generated for each branch using the respective data subsets. Back at step 520, if the dataset or attribute set is empty or if no adequately informative attributes remain, then the clustering process described above is implemented at step 570 to induce additional sub-partitions.

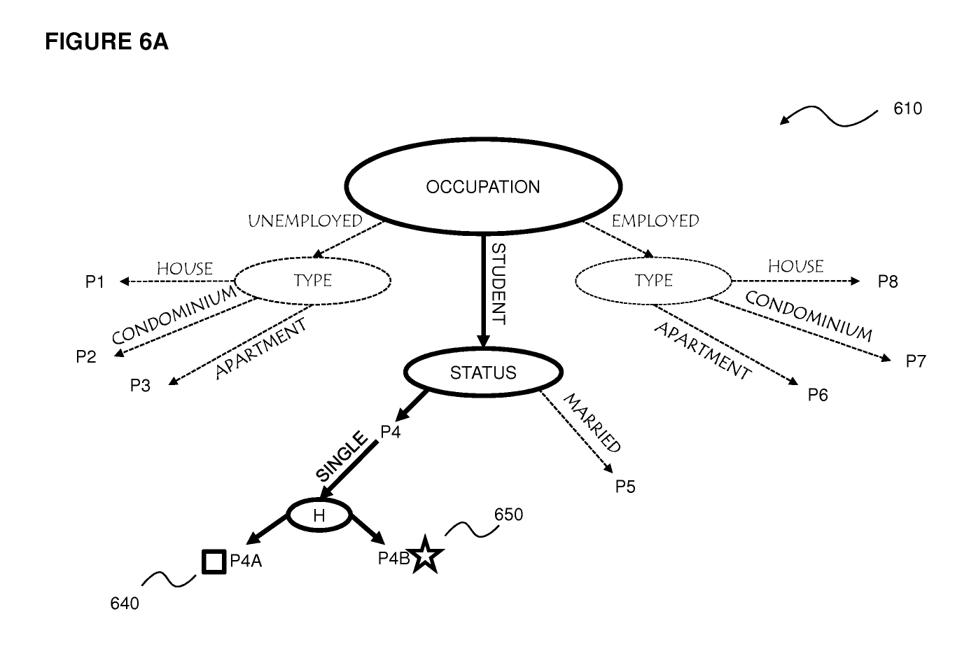

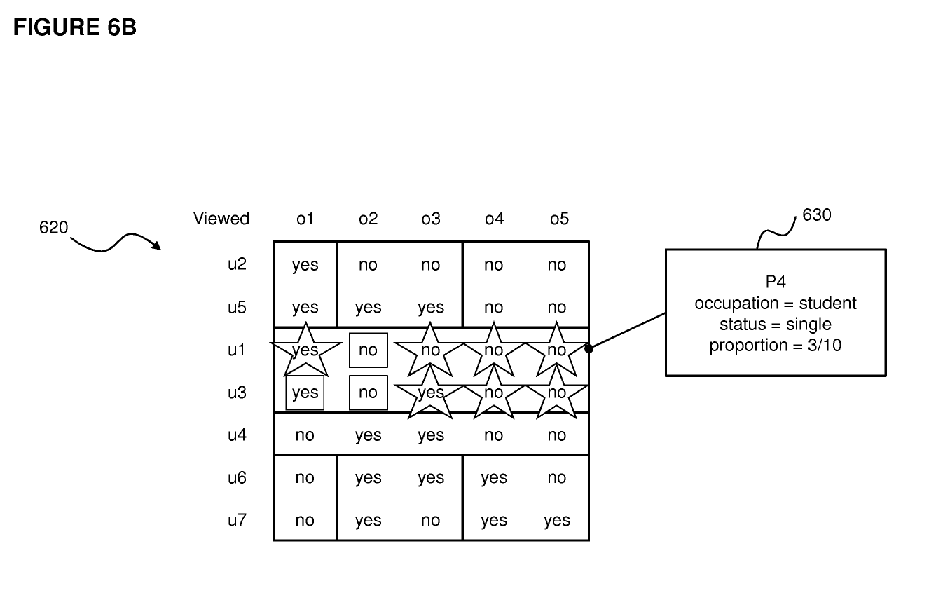

Referring now to FIGS. 6A-6B, an exemplary predictive decision tree is illustrated including the subpartitioning of select partitioned relational data. In particular, the examples of FIGS. 2, 4, and 6 provide non-limiting exemplary aspects that illustrate more specific aspects of a generalized system and method for predicting user interests that are subsequently used to determine offers to transmit from a recommender system to a user system. FIGS. 6A-6B illustrate an example of a partial execution of Process 3, and the resulting sub-partitioning of an existing partition. The exemplary sub-partitioning is for the “single” leaf partition, P4, also identified by element 630 in matrix 620. The generated exemplary decision tree 610 includes the introduction of a two-cluster clustering, resulting in clusters P4a and P4b (also identified by elements 640 and 650) to the “occupation=student→status=single” leaf, P4, which has a different proportion of “yes” responses that have been modeled in matrix 620 from the exemplary transaction table 230 from FIG. 2. Data points (e.g., u1,02; u3,01; u3,02) belonging to a first cluster P4a are identified by a square symbol. Data points (e.g., u1,01; u1,03; u1,04; u1,05; u3,03; u3,04; u3,05) belonging to a second cluster P4b (e.g., also a sub-partition) are identified by the star symbol. The assignment of each data point (e.g., u1,01; u3,02; etc.) in the corresponding partition 620 is illustrated using the exemplary square and star symbols. As described above, the assignment of data points of P4 to subpartitions P4a and P4b is determined as the most likely assignment, and the most likely assignment is one that has the maximum posterior probability (according to the expression described above in the exemplary context using Bayes' rule), computed by an EM algorithm or others as described above.

The exemplary aspects of the present disclosures provide a practical combination of decision tree learning and clustering that includes the advantages of both approaches along with the ease-of-interpretation of decision trees and the accuracy gains of optimized hidden clusters. The combined method improves the predictive accuracy of single decision trees learned from data, while retaining the interpretable and consequently explainable nature of decision trees. The choice of decision tree process and clustering process used in the combined method is flexible, in that any combination of tree and cluster learning may be applied.

It will be understood that in certain exemplary aspects of the present disclosure, the combination of decision trees with clustering has the effect of producing accurate predictions of user transactions. The follow on effect is that useful recommendations of offers can then be made to users based on such predictions. Such a combination is also useful for improving user trust when future offers are made and thus allows for improved user engagement in the disclosed recommender system.

It will further be understood that the exemplary aspects of the present disclosure are non-limiting and that the combination of decision trees and clustering is process-general, in that any decision tree construction process can be implemented along with any clustering process being implemented at the leaves of the decision tree.

According to one aspect of the present disclosure, a computer-implemented method recommends offers to a user. The method is implemented via one or more processors operating on one or more server systems. The method includes receiving in a recommender module attribute data stored on one or more memory devices. The attribute data is associated with one or more target users of the recommender module. An offer to transmit to the one or more target users is determined via one or more processors associated with the recommender module. The offer is based on at least a portion of the attribute data analyzed by a predictive process including a decision tree combined with a clustering process. The offer is output, sent or transmitted via one or more communication interfaces associated with a network. The outputting, sending, or transmitting of the offer us configured to be received by the one or more targeted users.

According to one aspect of the present disclosure, a computer-implemented method recommends offers to a user. The method is implemented via one or more processors operating on one or more server systems. The method includes receiving in a recommender module attribute data stored on one or more memory devices. The attribute data is associated with one or more target users of the recommender module. Attribute data received in a recommender module is stored on one or more memory devices. Additional attribute data is associated with one or more pre-selected offers to be distributed to one or more target users of the recommender module. Transaction data stored on one or more memory devices is received receiving in a recommender module/The transaction data is associated with one or more user-offer pairs. The user and offer are described in the received attribute data of the recommender module. An offer to transmit to the one or more target users is determined via one or more processors associated with the recommender module. The offer is based at least in part on the attribute data analyzed by a predictive process including a decision tree combined with a clustering process. The offer is output via one or more communication interfaces associated with a network. The outputting of the offer is configured to be received by the one or more targeted users.

Additional aspects of the above methods can include determining, via at least one of the one or more processors, an explanation associated with the offer; and outputting, sending, or transmitting the explanation, via at least one of the one or more communication interfaces where the outputting, sending, or transmitting of the explanation is configured to be received by the one or more target users. Other aspects of the method include receiving a response via at least one of the one or more communication interfaces, where the response is stored on at least one of the one or more memory devices. The response can include information relating to the one or more target users accepting or declining the offer. The response can also include explanation feedback from the one or more target users. It is also contemplated that the attribute data can include user demographic data, user description data, a plurality of pre-selected offers, or prior transaction data including target users responses to prior offers. The method can also include receiving in the recommender module updated attribute data, where the updated attribute data includes the response; and determining a second offer to transmit to the one or more target users, the offer based on at least a portion of the updated attribute data analyzed by a process including a decision tree combined with a clustering process. The clustering process can include determining based on probability distributions a plurality of hidden clusters in the decision tree. The one or more target users can include a mobile device, and at least a portion of the network can include a wireless network.

According to one aspect of the present disclosure, a computer-implemented method recommends offers to a user. The method is implemented via one or more processors operating on one or more server systems. The method includes receiving attribute data associated with one or more target users. An offer to transmit to the one or more target users is determined. The offer is based on at least a portion of the attribute data analyzed by a predictive process including a decision tree combined with a clustering process. The offer is configured to be received by the one or more targeted users and is output.

Additional aspects of the above methods can include receiving additional attribute data associated with one or more preselected offers to be distributed to the one or more target users, where the offer is further based on at least a portion of the additional attribute data. The methods can also include receiving transactional data associated with one or more user-offer associations based on the attribute data and the additional attribute data, where the offer is further based on at least a portion of the transactional data. The methods can further include determining an explanation associated with the offer; and outputting the explanation, where the explanation is configured to be received by the one or more target users. For yet other aspects of the methods can include receiving a response transmitted by the one or more target users, where the response includes information relating to the one or more target users accepting or declining the offer. The methods can also include receiving a response transmitted by the one or more target users, where the response includes explanation feedback from the one or more target users. Additionally, the attribute data can include user demographic data and user description data, where the additional attribute data includes a plurality of pre-selected offers, and the transaction data includes prior transactions including target users responses to prior offers. Other aspects of the methods can include receiving a response transmitted by the one or more target users, where the response is associated with the explanation; receiving updated attribute and transactional data, wherein the updated transactional data includes the response; and determining a second offer to transmit to the one or more target users, where the offer is based on at least a portion of the updated attribute data analyzed by a predictive process including a decision tree combined with a clustering process. The methods can further include the clustering process determining based on probability distributions of a plurality of hidden clusters in data partitions generated by the decision tree. The methods can further include the one or more target users having a mobile device, and the network including at least in part a wireless network.

According to another aspect of the present disclosure, a system for recommending offers includes one or more non-transitory physical computer-readable storage media configured to store attribute and transaction data associated with one or more target users. The attribute and transaction data include target user identifications, offer attributes, and prior target user transaction data. A recommender component includes one or more communication interfaces for connecting with the storage media. The communication interfaces are configured to send and receive data. The recommender component further includes one or more processors operative to generate a recommended offer for at least one of the one or more target users by implementing acts including receiving the attribute and transaction data from at least one of the one or more storage media. The recommended offer is determined based on at least a portion of the attribute and transaction data analyzed by a predictive process including a decision tree combined with a clustering process. The offer is output via at least one of the one or more communication interfaces. The outputting of the offer is configured to be received by the one or more targeted users.

Additional aspects of the above systems can include the one or more processors being further operative to generate a recommended offer for at least one of the one or more target users by implementing additional acts including determining an explanation associated with the offer; and outputting the explanation, via at least one of said one or more communication interfaces, where the outputting of the explanation is configured to be received by the one or more targeted users. The systems can include the one or more processors being further operative to generate a recommended offer for at least one of the one or more target users by implementing additional acts including receiving a response via at least one of the one or more communication interfaces, where the response is associated with the explanation. The systems can include the response having information relating to the one or more target users accepting or declining the offer. The system can include the response having explanation feedback from the one or more target users. The systems can also include receiving in the recommender component updated attribute and transaction data, wherein the updated transaction data includes data related to the response; and determining a second offer to transmit to the one or more target users, where the offer is based on at least a portion of the updated attribute data analyzed by a process including a decision tree combined with a clustering process. The systems can also include the clustering process determining based on probability distributions a plurality of hidden clusters in data partitions generated by the decision tree.

According to yet another aspect of the present disclosure, a method includes receiving in a recommender system attribute and transactional data stored on one or more memory devices. The attribute and transactional data are associated with one or more target users of the recommender system. An offer to transmit to the one or more target users is determined via one or more processors associated with the recommender system. The offer is based on at least a portion of the attribute and transaction data analyzed by a predictive process including a decision tree combined with a clustering process. The offer is output via one or more communication interfaces associated with a network. The outputting of the offer is configured to be received by the one or more targeted users.

Additional aspects of the above methods include determining an explanation associated with the offer; and outputting the explanation, via at least one of the one or more communication interfaces, where the outputting of the explanation is configured to be received by the one or more target users. The methods can also include receiving a response via at least one of the one or more communication interfaces; receiving in the recommender system updated attribute and transactional data, wherein the updated transactional data includes the response data; and determining a second offer to transmit to the one or more target users, the offer based on at least a portion of the updated attribute and transactional data analyzed by a process including a decision tree combined with a clustering process.

According to further aspects of the present disclosure, one or more physical machine-readable storage media include instructions which, when executed by one or more processors, cause the one or more processors to perform the above methods.

Each of these embodiments and obvious variations thereof is contemplated as falling within the spirit and scope of the claimed invention, which is set forth in the following claims.

1-20. (canceled)

21. A computer-implemented method for recommending offers to a user, the method implemented via one or more processors operating on one or more server systems, the method comprising:
receiving attribute data associated with one or more target users at said one or more server systems;
analyzing at least a portion of said attribute data using a predictive process, said predictive process implemented using a decision tree combined with a clustering process using one or more clusters,
wherein said clustering process comprises assigning data points within said portion of attribute data to the one or more clusters,
said analyzing performed by said one or more processors;
determining an offer to transmit to said one or more target users, said offer based on at least a portion of said analyzed attribute data, said determining performed by said one or more processors;
determining an explanation associated with said offer; said determining performed by said one or more processors and
outputting said offer and said explanation, said offer and said explanation being configured to be received by said one or more targeted users, said outputting performed by said one or more server systems.

22. The computer-implemented method of claim 21, wherein said offer is further based on at least a portion of received additional attribute data, said received additional attribute data associated with one or more first preselected offers to be distributed to said one or more target users.

23. The computer-implemented method of claim 22, further comprising receiving transactional data associated with one or more user-offer associations based on said attribute data and said received additional attribute data at said one or more server systems, said offer further based on at least a portion of said transactional data.

24. The computer-implemented method of claim 21, further comprising receiving a response transmitted by said one or more target users at said one or more server systems, said response including information relating to said one or more target users accepting or declining said offer.

25. The computer-implemented method of claim 21, further comprising receiving a response transmitted by said one or more target users at said one or more server systems, said response including explanation feedback from said one or more target users.

26. The computer-implemented method of claim 23, wherein said attribute data includes user demographic data and user description data, said received additional attribute data includes a plurality of second pre-selected offers, and said transaction data includes prior transactions including target users responses to prior offers.

27. The computer-implemented method of claim 21, further comprising:
receiving a response transmitted by said one or more target users at said one or more server systems, said response associated with said explanation;
receiving updated attribute and transactional data at said one or more server systems, wherein said updated transactional data includes said response;
analyzing, using said one or more processors, at least a portion of said updated attribute data using said predictive process; and
determining a second offer to transmit to said one or more target users, said determining performed by said one or more processors

28. The computer-implemented method of claim 21, wherein
said one or more clusters comprise a plurality of hidden clusters in data partitions generated by said decision tree;
said clustering process further comprises optimizing said assigning of data to said plurality of hidden clusters based on probability distributions.

29. The computer-implemented method of claim 21, wherein said one or more target users utilize one or more user devices, said one or more user devices communicatively coupled to said server systems by at least one network, further wherein said one or more devices includes a mobile device, and said at least one network includes at least in part a wireless network.

30. A system for recommending offers, the system comprising:
one or more non-transitory physical computer-readable storage media configured to store attribute and transaction data associated with one or more target users, said attribute and transaction data including target user identifications, offer attributes, and prior target user transaction data;
a recommender component including one or more communication interfaces for connecting with said storage media, said communication interfaces configured to send and receive data, said recommender component further including one or more processors, said one or more processors operative to generate a recommended offer for at least one of said one or more target users, said generation comprising
receiving said attribute and transaction data from at least one of said one or more storage media;
analyzing at least a portion of said attribute data using a predictive process, said predictive process implemented using a decision tree combined with a clustering process using one or more clusters,
wherein said clustering process comprises assigning data points within said portion of attribute data to the one or more clusters,
determining said recommended offer based on at least a portion of said analyzed attribute and transaction data;
determining an explanation associated with said offer; and
outputting said offer and said explanation, via at least one of said one or more communication interfaces, said outputting of said offer and said explanation configured to be received by said one or more target users.

31. The system of claim 30, wherein said generation further comprises receiving a response via at least one of said one or more communication interfaces, said response associated with said explanation.

32. The system of claim 31, wherein said response includes information relating to said one or more target users accepting or declining said offer.

33. The system of claim 31, wherein said response includes explanation feedback from said one or more target users.

34. The system of claim 30, further comprising:
receiving in said recommender component updated attribute and transaction data, wherein said updated transaction data includes data related to said response; said receiving performed by said one or more communication interfaces and
analyzing, using said one or more processors, at least a portion of said updated attribute data using said predictive process; and
determining a second offer to transmit to said one or more target users, said offer based on at least a portion of said analyzed updated attribute data, said determining performed by said one or more processors.

35. The system of claim 30, wherein
said one or more clusters comprise a plurality of hidden clusters in data partitions generated by said decision tree;
said clustering process further comprises optimizing said assigning of data to said plurality of hidden clusters based on probability distributions.

36. One or more non-transitory physical machine-readable storage media including instructions which, when executed by a recommender system, said recommender system implemented using one or more processors operating on one or more server systems, and said recommender system comprising one or more communication interfaces coupled to a network, cause the one or more processors to perform operations comprising:
receiving in said recommender system attribute and transactional data from one or more memory devices, said attribute and transactional data being associated with one or more target users of said recommender system;
analyzing at least a portion of said attribute data using a predictive process, said predictive process implemented using a decision tree combined with a clustering process using one or more clusters,
wherein said clustering process comprises assigning data points within said portion of attribute data to the one or more clusters,
determining, by said one or more processors associated with said recommender system, an offer to transmit to said one or more target users, said offer based on at least a portion of said analyzed attribute and transaction data;
determining by said one or more processors associated with said recommender system an explanation associated with said offer; and
outputting said offer and said explanation, said outputting performed by the one or more communication interfaces over said network, said outputting of said offer and said explanation configured to be received by said one or more targeted users.

37. The one or more non-transitory physical machine-readable storage media of claim 36, further including instructions which cause the one or more processors to perform operations further comprising receiving a response via at least one of said one or more communication interfaces, said response associated with said explanation.

38. The one or more non-transitory physical machine-readable storage media of claim 37, wherein said response includes information relating to said one or more target users accepting or declining said offer.

39. The one or more non-transitory physical machine-readable storage media of claim 36, further including instructions which cause the one or more processors to perform operations further comprising:
receiving a response via at least one of said one or more communication interfaces;
receiving in said recommender system updated attribute and transactional data, wherein said updated transactional data includes said response data;
analyzing, using said one or more processors, at least a portion of said updated attribute data using a predictive process implemented using a decision tree combined with a clustering process using one or more clusters; and
determining a second offer to transmit to said one or more target users, said offer based on at least a portion of said analyzed updated attribute and transactional data.

40. The one or more non-transitory physical machine-readable storage media of claim 36, wherein
said one or more clusters comprise a plurality of hidden clusters in data partitions generated by said decision tree;
said clustering process further comprises optimizing said assigning of data to said plurality of hidden clusters based on probability distributions.
